(19) United States
(12) Patent Application Publication
(10) Pub. No.: US 2009/0309847 A1
(43) Pub. Date: Dec. 17, 2009

(54) APPARATUS AND METHOD FOR PROVIDING MULTI-TOUCH INTERFACE CAPABILITY

(75) Inventors: Stuart Allen Russell, Ottawa (CA); Jason William Flick, Ottawa (CA)

Correspondence Address: VINCENT PATENT AGENCY, 11-300 EARL GREY DRIVE, SUITE 202, KANATA, ON, K2T 1C1, CA

(73) Assignee: YOU I LABS, INC., Kanata (CA)

(21) Appl. No.: 12/483,412

(22) Filed: Jun. 12, 2009

Related U.S. Application Data
(60) Provisional application No. 61/061,104, filed on Jun. 12, 2008.

(51) Int. Cl. G06F 3/041

(52) U.S. Cl. 345/173

(57) ABSTRACT

An apparatus and method for providing multi-touch human to computing device interface capability on devices having single-touch interface devices. The apparatus and method use heuristics based analysis of successive touch point X,Y coordinate pairs provided by the single-touch interface device to identify a multi-touch occurrence. A further heuristics based function is employed to derive X,Y coordinates for a second touch point from two successive pairs of X,Y coordinates provided by single-touch interface device.

### CROSS-REFERENCE TO RELATED APPLICATIONS

This application claims priority from U.S. Provisional Patent Application Ser. No. 61/061,104, filed Jun. 12, 2008, the entirety of which is incorporated herein by reference.

### FIELD OF INVENTION

The present invention relates to the field of human-computing device interface mechanisms. In particular, to an apparatus and a method for providing a multi-touch interface capability.

### BACKGROUND

As computing devices become more portable and the human interactions with them become more sophisticated, the use of touch interfaces (e.g. track-pads, pen-tablets, and touch-sensitive screens) is becoming more common. The touch interfaces can typically respond to the touch of a human digit (i.e. finger) and/or of a stylus (a.k.a. pen). The computing devices that incorporate or support a touch interface include, for example, personal computers, personal digital assistants (PDA), mobile telephones (a.k.a. cellular phones), portable music players, portable gaming consoles, portable navigation devices and other similar computing devices.

Typically the touch interfaces are adapted to sensing and tracking the touch and the movement of a single finger or stylus (hereinafter referred to as single-touch interfaces). The single-touch interface typically provides as output for consumption by other parts of the computing device (e.g. an operating system, one or more applications) an X,Y coordinate pair that signifies the location of a touch point on a Cartesian plane corresponding to a touch sensitive of the interface. When the touch point subsequently moves, a sequence of X,Y coordinate pairs are generates representing the locations of the touch-point over time.

Recently a number of devices (e.g. the MicroSoft® Surface™ computing platform) that support a multi-touch interface have become available. The multi-touch interface used in these devices is adapted to sensing and tracking multiple concurrent touch points. The multi-touch interface is dependent on the use of touch sensitive interface devices (e.g. touch-sensitive screens, track-pads) that are adapted to providing one or two concurrent X,Y coordinate pairs that each represent a different one of one or two touch points.

The benefits of multi-touch interfaces include the ability to support more complex interactions with the human user compared to the single-touch interface. The single-touch interfaces typically support function such as pointing, selecting and scrolling in one dimension. The multi-touch interfaces can add to the functions supported by the single-touch interfaces additional functions such as zooming (e.g. via pinching together and spreading of the fingers), rotating, swiping and other similar functions.

Many users and producers of existing single-touch interface equipped computing devices desire some of the advantages of a multi-touch interface. While the operating system and/or applications on single-touch interface equipped computing devices can, in some cases, be upgraded with multi-touch interface capability, the single-touch physical interface devices (i.e. hardware) and/or associated driver software can not typically be practically or economically upgraded to support multi-touch capability.

What is needed is a mechanism for providing multi-touch interface capability on computing devices equipped with single-touch physical interface devices and/or associated driver software.

### SUMMARY OF INVENTION

An apparatus and method for providing multi-touch, human to computing device, interface capability on devices having single-touch interface devices. The apparatus and method use heuristics based analysis of successive touch point X,Y coordinate pairs provided by the single-touch interface device to identify a multi-touch occurrence. A further heuristics based function is employed to derive X,Y coordinates for a second touch point from two successive pairs of X,Y coordinates provided by single-touch interface device.

In one aspect of the invention, a computing device for providing a multi-touch interface capability comprising: a single-touch interface device that provides: an X,Y coordinate pair that represents the location of a touch point on a surface of the interface device responsive to the occurrence of a single touch event; and an X,Y coordinate pair that is a function of the locations of both a first touch point and a second touch point responsive to the occurrence of a multiple touch event; a multi-touch detector for: determining if a multiple touch event has occurred by applying a heuristic based multiple touch detection analysis function to a first X,Y coordinate pair, provided by the interface device representing the location of a first touch point, and a second X,Y coordinate pair, provided by the interface device responsive to a second touch; and deriving, when a multiple touch event is determine to have occurred, a derived X,Y coordinate pair representing the location of the second touch point by applying a heuristic based blended touch function to the first X,Y coordinate pair and the second X,Y coordinate pair; and at least one of an operating system and an application, for receiving the first X,Y coordinate pair and the derived X,Y coordinate pair representing the location of the second touch point.

In another aspect of the invention, a method for providing a multi-touch interface capability on a computing device having a single-touch interface device, the single-touch interface device provides an X,Y coordinate pair that represents the location of a touch point on a surface of the interface device at the occurrence of a single touch event or alternatively an X,Y coordinate pair that is a function of the locations of both a first touch point and a second touch point at the occurrence of a multiple touch event, the method comprising the steps of: receiving, from the interface device, a first X,Y coordinate pair representing the location of a first touch point; receiving, from the interface device, a second X,Y coordinate pair when a second touch occurs; determining if a multiple touch event has occurred by applying a heuristic based multiple touch detection analysis function to the first X,Y coordinate pair and the second X,Y coordinate pair; deriving, when a multiple touch event is determine to have occurred, a derived X,Y coordinate pair representing the location of the second touch point by applying a heuristic based blended touch function to the first X,Y coordinate pair and the second X,Y coordinate pair; and providing, to a touch point consuming application, the first X,Y coordinate pair and the derived X,Y coordinate pair representing the location of the second touch point.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of a computing device for providing multiple touch interface capability.

FIGS. 2A-C are schematic representations of a time sequence illustrating a multiple touch occurrence on a single-touch interface device.

FIG. 3 is schematic representation of a successive approximation approach for the blended touch function.

FIG. 4 is a schematic representation of a sequence of visual target pairs being displayed on a touch sensitive display device surface.

FIG. 5 is a schematic representation of a multiple touch scenario where a second touch point is subsequently moved.

FIG. 6 is a schematic representation of touch point coordinate data flow between the interface device, the multi-touch detector and an application.

FIGS. 7A-B are schematic representations of two exemplary embodiments for highlighting the initial touch location on the touch sensitive surface.

FIG. 8 is a flow diagram representing exemplary steps in a method for providing multiple touch interface capability.

### DETAILED DESCRIPTION

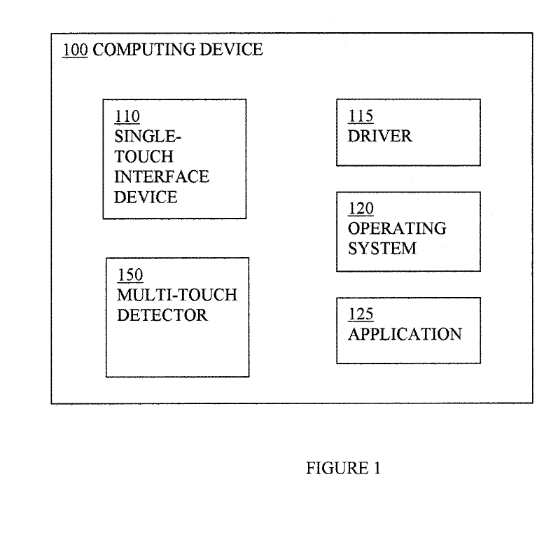

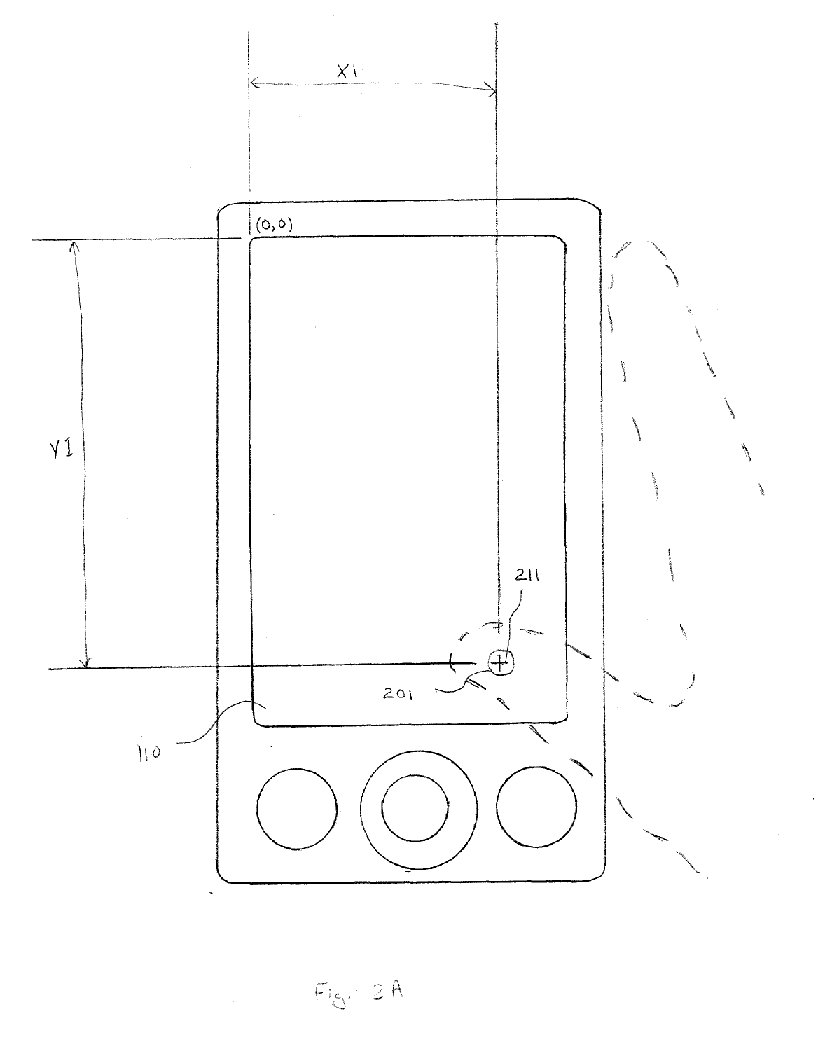

FIG. 1 is a schematic representation of a computing device 100, for providing multiple touch interface capability, comprising a single-touch interface device 110, an associated driver 115, an operating system 120 and one or more software applications 125. The computing device 100 can be a personal digital assistant (PDA), a mobile phone, a multimedia player, a personal computer (PC), or other similar device having the ability to run (i.e. execute) an operating system and software applications and is equipped with a single-touch interface device 110. The interface device 110 can be a touch-sensitive screen, a track-pad or a similar device that can sense a single touch (i.e. contact) on a substantially planar surface. The position, on the planar surface, of the touch can be represented by an X,Y coordinate pair that can be output by the interface device 110. In an alternative embodiment the X,Y coordinate pair that can be output via the driver 115. The X,Y coordinate pair is comprised of an X value and a Y value that, respectively, represent a linear displacement along an X-axis and a Y-axis measured relative to a reference point (e.g. the upper left-hand corner). The X-axis and Y-axis are orthogonal (i.e. at a 90° angle relative to each other) and define a Cartesian plane. The location of the touch on the Cartesian plane (i.e. on the interface device 110) can be referred to as a touch-point. A touch-point can be described by an X,Y coordinate pair.

The interface device 110 can comprise any well-known touch-sensitive device having a touch sensitive surface 112 capable of sensing a touch made by a human digit (e.g. finger). Alternatively, the interface device 110 can be capable of sensing a touch made by either of a human digit or a stylus (a.k.a. a pen). The computing device 100 further comprises a multi-touch detector 150. The multi-touch detector 150 can receive, from the interface device 110, notification of touch events such as, for example, an initial touch event, a move event, and a lift event. An initial touch event indicates that a new touch event has been detected and the notification includes an X,Y coordinate pair representing the position of a current touch-point. The interface device 110 can provide a move event including the X,Y coordinate pair of a current touch-point when the touch point has moved to a location that is not substantial the same as the location reported in a preceding event notification (e.g. an initial touch or move event). When the finger (or stylus) is removed from the touch sensitive surface 112, the interface device 110 can provide a lift event notification. The multi-touch detector 150 can receive event notifications from the interface device 110 directly or in alternative embodiment via one or more of the driver 115 and the operating system 120.

The multi-touch detector 150 waits to receive an initial touch event including an X,Y coordinate pair indicating the location of a first touch point. The multi-touch detector 150 can record a timestamp to be associated with the initial touch event. The multi-touch detector 150 then waits to receive a move event including a second X,Y coordinate pair. The multi-touch detector 150 can record a timestamp to be associated with this and any subsequent move events. In a preferred embodiment the move event notification generation rate, provided by the interface device 110, is one move event notification every 50 milliseconds (mS) or less when the touch point is moving. When a new X,Y coordinate pair that is substantially (i.e. discernibly) different from the previous X,Y coordinate pair is received, the displacement (i.e. the change in the X and the Y coordinate values) between the adjacent touch point locations is analyzed. In the context of this document, adjacent touch point locations refers to touch point locations identified in a first (e.g. an initial touch or move) and a second (e.g. move) immediately subsequent event notification.

The adjacent touch point locations (i.e. X,Y coordinates) are analyzed using a heuristics based approach. The analysis seeks to identify anomalous adjacent touch point locations. For example, adjacent touch point locations that are better attributed to the second touch point being the result of a touch by a second finger (or stylus) rather than movement of the finger (or stylus) associated with the first touch point. This can be the case when, for example, the linear displacement between the first touch point and the second touch point is too great for the time interval between the associated event notifications (i.e. a single finger or stylus could not have been moved fast enough to result in the two adjacent touch points). Further, heuristic analysis of adjacent touch point locations can be used, after a multiple touch event has been detected, to determine when the second finger has been lifted and the touch event has reverted to a single-touch point (e.g. when the current touch point location suddenly returns to the location of the original single-touch point).

When a multiple touch occurrence has been detected, an angular relationship between the first and second touch points that typically is accurate can be derived from the X,Y coordinate pairs associated with each touch point. Although a distance between the first and the second touch points can also be derived from the associated coordinate pairs, the derived distance is typically inaccurate. The inaccuracy is a result of how well-known single-touch interface devices 110 operate. Given that the interface device 110 is designed to sense a single touch, when presented with a multiple touch, the second X,Y coordinate pair provided in the move event by the interface device 110 does not represent the location of the second touch point but rather a location that is a function of both the first touch point and the second touch point.

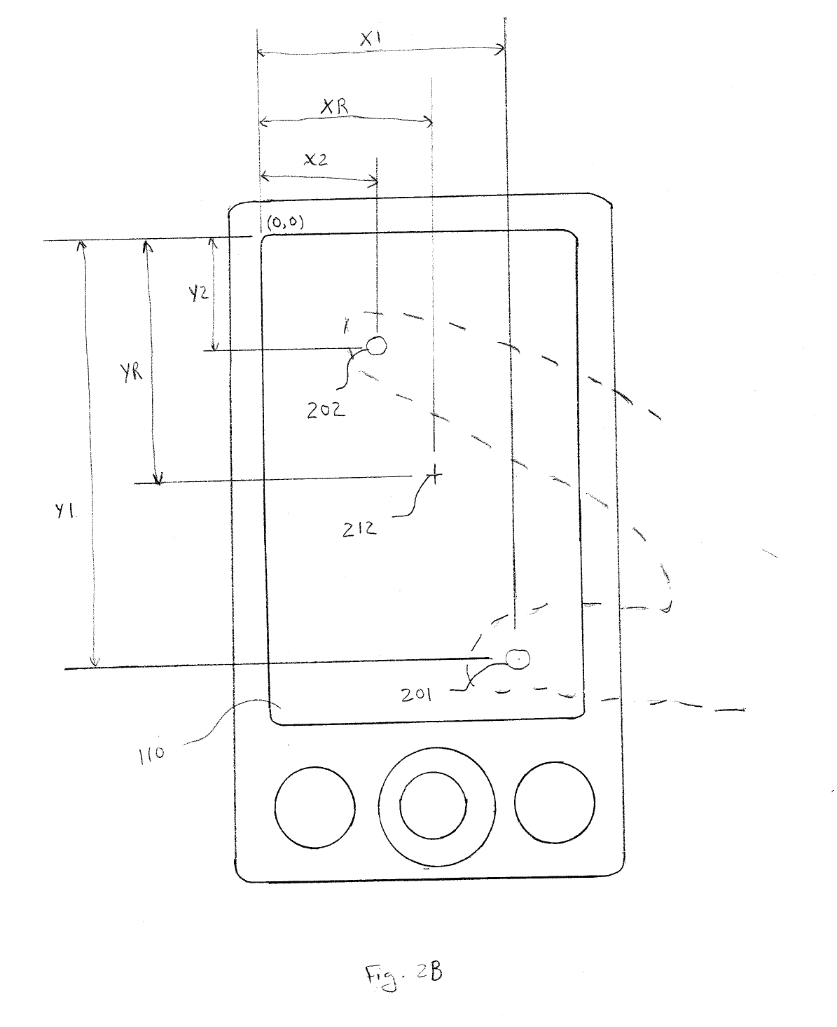

FIGS. 2A-C are schematic representations of a time sequence illustrating a multiple touch occurrence on a single-touch interface device 110. FIG. 2A represents a first point in time when a first finger of a hand (represented in FIGS. 2A-C in chain line silhouette) touches the interface device 110 at a first actual touch point 201 represented for illustrative purposes by a small circle 201. The location of the first actual touch point 201 corresponds to the coordinate pair X1,Y1. X and Y coordinates in FIGS. 2A-C are relative to a (0,0) reference point corresponding to the upper left-hand corner of the interface device 110. The location reported by the interface device 110 for the first touch point is represented for illustrative purposes by a small cross 211, thereinafter the first reported touch point 211. The first reported touch point 211 corresponds to coordinate pair X1,Y1 and substantially matches the first actual touch point 201.

FIG. 2B represents a second subsequent point in time when a second finger of the hand also touches the interface device 110 at a second actual touch point 202 (represented by a small circle 202) that corresponds to the coordinate pair X2,Y2. The first finger continues to touch the interface device 100 at the first actual touch point 201. The interface device 110 reports a single touch location represented by a small cross 212 corresponding to coordinates XR, YR. The location corresponding to coordinates XR,YR, the reported touch point 212, typically differs from the second actual touch point 202 and lies between the first actual touch point 201 and the second actual touch point 202.

Typically the location of the reported touch point 212, (XR,YR) is a non-linear (e.g. logarithmic) function (hereinafter the blended touch function) of the first and the second actual touch point locations 201, 202 that varies with the locations of the first and the second actual touch points 201, 202 relative to the interface device 110 surface. For example, in a typical resistance measurement based interface device 110, the X, Y coordinate pair for a single touch is derived from a resistance measurement along each of the X and Y axis that increases logarithmically with the displacement from (i.e. distance from) a reference point (e.g. the upper left-hand corner of the touch surface). When such an interface device is subjected to a multiple touch occurrence, the resistance measurements along the X and Y axis can, for example, represent an average of resistances associated with the axis position of each of the two touch points (i.e. an average of two logarithmic values for each of the X and Y axis). Therefore, the XR,YR coordinates provided by the interface device 110 do not correspond to the location of the second actual touch point 202.

The blended touch function can be determined using heuristic testing methods. For example, multiple touch occurrences at a plurality of representative locations on the touch sensitive surface 112 can be made and the actual touch point locations (e.g. X1,Y1 and X2,Y2) recorded together with the first and second X,Y coordinate pairs (i.e. X1,Y1 and XR,YR) produced by the interface device 110. One or more of various well-known mathematical techniques can be used to derive the blended touch function or alternatively an approximation of the blended touch function from the recorded data. An algorithm based on the derived blended touch function can be used to derive a corrected location (i.e. XE,YE coordinate pair) for the second touch point from subsequently received first and second coordinate pairs (e.g. X1,Y1 and X2,Y2) returned by the interface device 110. The algorithm can, for example, be in the form of one or more mathematical functions that can be evaluated for the first and second X,Y coordinate pairs (i.e. X1,Y1 and XR,YR) produced by the interface device 110 to generate a derived location (i.e. XE,YE) for the second touch point.

In an exemplary embodiment, an algorithm based on the blended touch function can be implemented as follows:

nTempX=XR*2-X1;

nTempY=YR*2-Y1;

XE=(nTempX+nTempY/5)*0.8;

YE=(nTempY+nTempX/10)

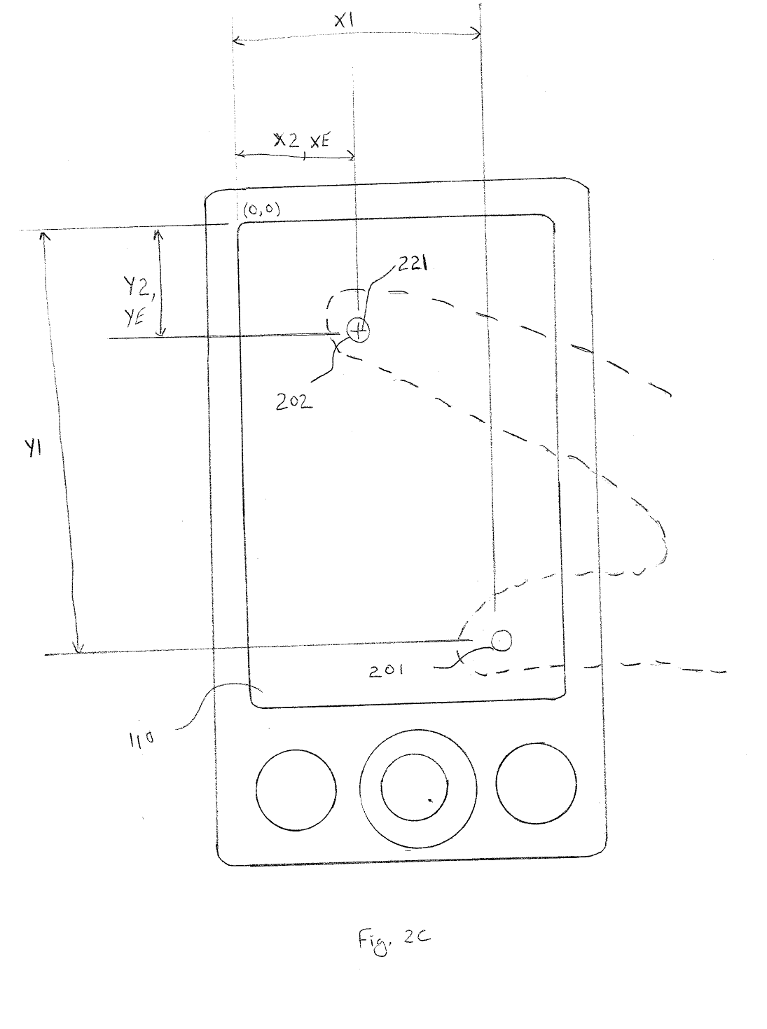

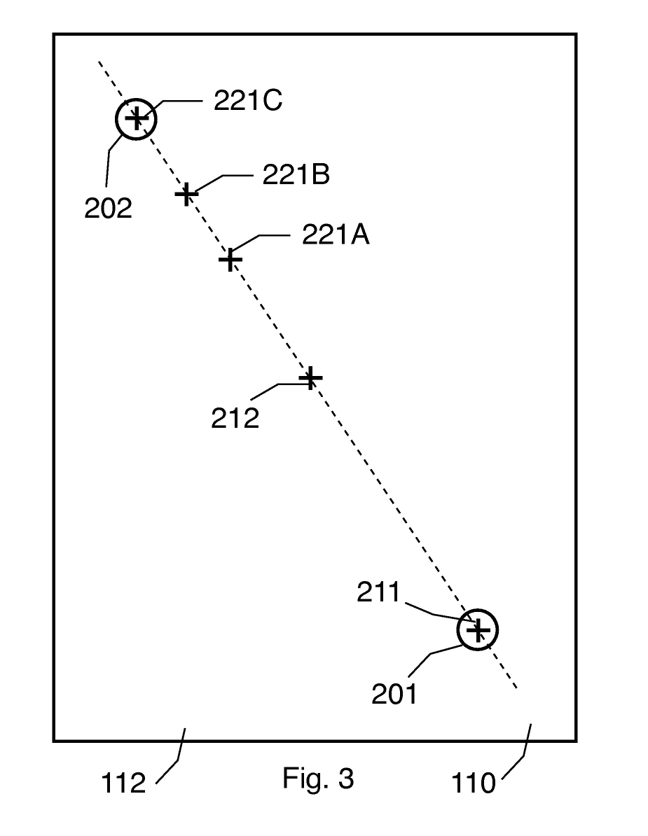

FIG. 3 is a schematic representation of a successive approximation approach for the blended touch function. In an alternative embodiment, the algorithm can be in the form of a mathematical function that is first evaluated for the first and second X,Y coordinate pairs 211, 212 produced by the interface device 110 for first and second touch points 201, 202 to generate an estimated corrected location 221A for the second touch point 202. The blended touch function can subsequently be recursively evaluated for the first X,Y coordinate pair 211 produced by the interface device 110 and the estimated corrected location 221A for the second touch point resulting from the previous evaluation of the function. Each successive evaluation of the function generates a more accurate estimated corrected location (e.g. 221B, 221C) for the second touch point. The function can be recursively evaluated until a pre-determined accuracy threshold is exceeded, or alternatively until a pre-determined number of evaluations have been completed, thereby mitigating a requirement for computing resources to perform the evaluations and minimizing a time delay in generating a final estimated location (e.g. 221C) for the second touch point.

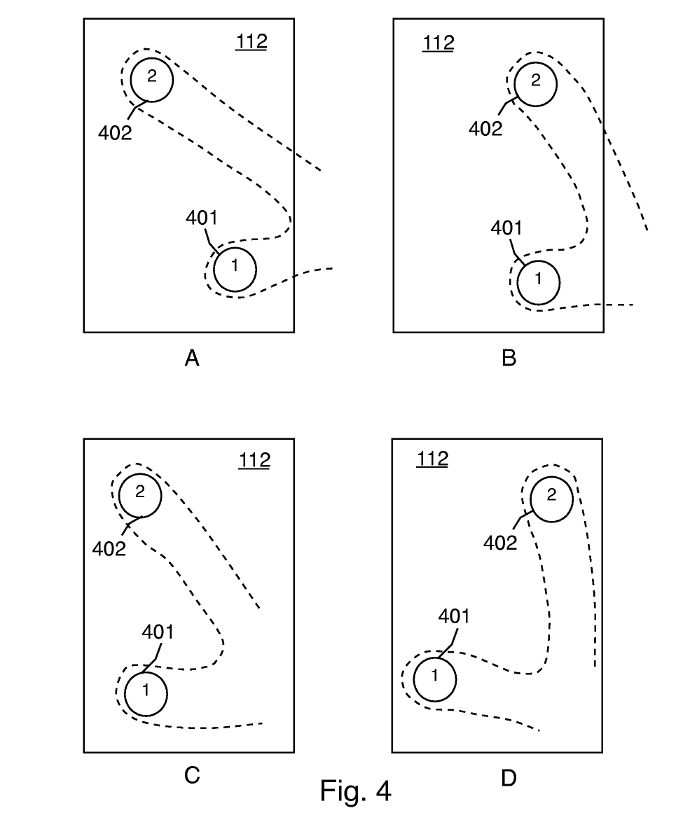

In an alternative embodiment when the interface device 110 is a touch sensitive display device, the blended touch function can be characterized using a calibration technique in which a plurality of visual target pairs at representative locations are sequentially presented on the display. FIG. 4 is a schematic representation of a sequence A, B, C, D of visual target 401, 402 pairs being displayed on a touch sensitive display device surface 112. A user is instructed to sequentially touch the display surface 112 at the location of each visual target 401 402 pair. For each visual target 401, 402 pair, a first and a second X,Y coordinate pair (i.e. X1,Y1 and XR,YR) produced by the interface device 110 and the actual locations (i.e. X1,Y1 and X2,Y2) of the visual target 401, 402 pairs are recorded. Any of various well-know mathematical techniques can be used to generate entries in a look-up table that permits the first and second X,Y coordinate pairs (i.e. X1,Y1 and XR,YR) produced by the interface device 110 during a subsequent multiple touch event to be used to look-up a corrected location (i.e. XE,YE) for a second touch point 202 in the subsequent multiple touch event.

Referring again to FIGS. 2A-C, FIG. 2C represents a third subsequent point in time when the first and second finger continue to touch the interface device 110 at the first actual touch point 201 and the second actual touch point 202 respectively. In accordance with the present invention a derived touch point 221, represented by a small cross, at coordinates XE,YE is derived, using the blended touch function, for the second touch point 202. The derived touch point 221 is alternatively substantially the same as the actual second touch point 202 (i.e. X2, Y2), or is within a pre-determined accuracy threshold of the actual second touch point 202.

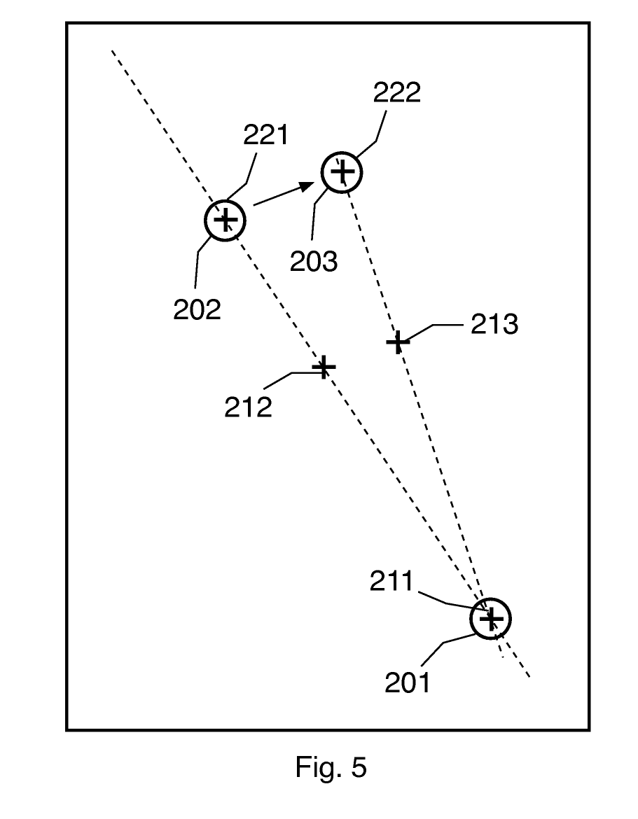

When a multiple touch scenario has been detected as described above, the interface device 110 can subsequently generate a plurality of move notifications, each including a X,Y coordinate pair, when a finger (or stylus) in contact with the touch sensitive surface 112 is moved. A third and one or more subsequent X,Y coordinate pairs can be used to derive updated locations for the second finger at subsequent points in time. The third and subsequent X,Y coordinate pairs are subject to the same inaccuracy as described above with reference to the second touch point. Similarly, the blended touch function can be used to derive corrected locations for a revised (i.e. updated) second touch point based on the third and subsequent X,Y coordinate pairs, assuming that the first touch point has not changed (i.e. that the first finger or stylus has not moved). FIG. 5 is a schematic representation of a multiple touch scenario where a second touch point is subsequently moved. Initial a multiple touch occurs comprising a first touch point 201 and a second touch point 202. The interface device 110 provides a touch event containing X,Y coordinates for the first touch location 211 and a move event containing X,Y coordinates for what the interface device 110 takes to be a move to location 212. The multi-touch detector 150 applies heuristics to detect that a multiple touch has occurred and by applying a blended touch function derives a location 221 for the second touch point 202. When the second touch point 202 is subsequently moved to a relocated second touch point 203 (indicated by the arrow), while the first touch point 201 remains stationary, the interface device 110 provides a move event containing X,Y coordinates for what the interface devices 110 takes to be a move to location 213. The multi-touch detector 150 applies heuristics to detect that a move of the second touch point in the multiple touch has occurred and by applying the blended touch function derives a location 222 for the relocated second touch point 203.

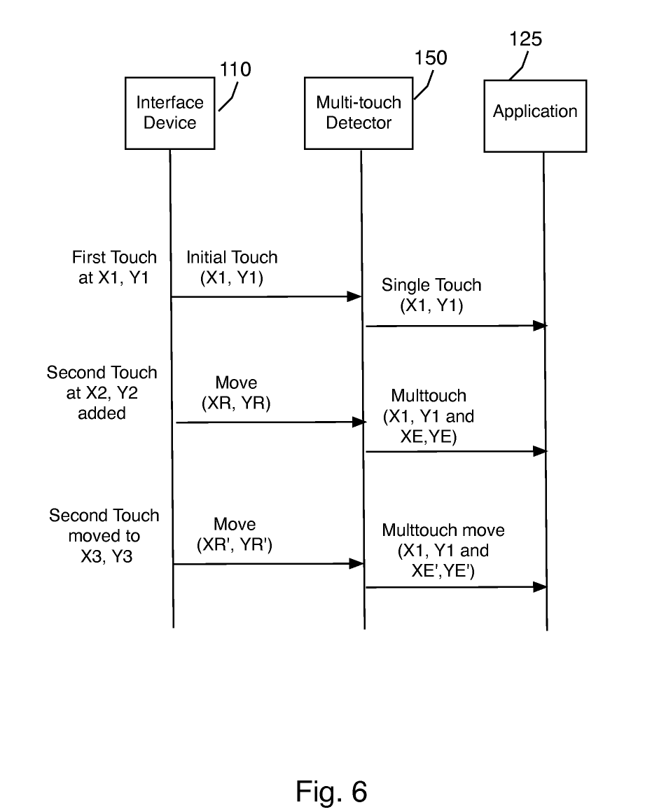

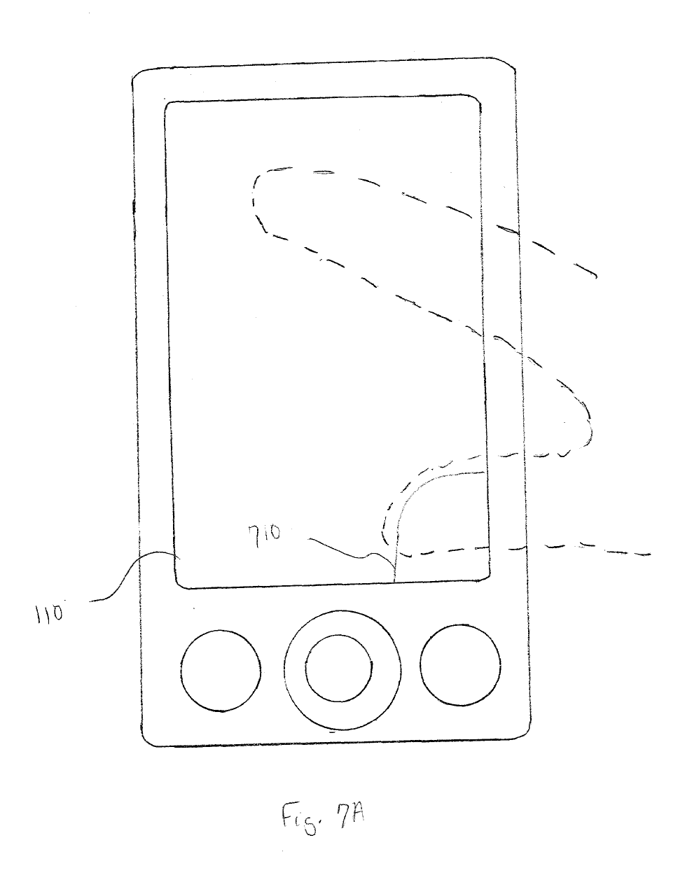

FIG. 6 is a schematic representation of touch point coordinate data flow between the interface device 110, the multi-touch detector 150 and an application 125. The application 125 can be any touch point consuming application 125 including the operating system 120. When a first touch occurs at X1,Y1 the interface device 110 sends an Initial touch event containing X1,Y1 to the multi-touch detector 150. The multi-touch detector 150 not having yet detected a multiple touch send a Single Touch event containing X1,Y1 to the application 125. Subsequently, when a second touch at X2,Y2 is added to the first touch, the interface device 110 sends a Move event containing XR,YR to the multi-touch detector 150. The multi-touch detector applies heuristic analysis as described above, determines that a multiple touch event has occurred, and derives a location XE,YE for the second touch. The multi-touch detector 150 then sends a Multi-touch event containing X1,Y1 and XE,YE to the application 125. The Multi-touch event sent by the multi-touch detector is substantially indistinguishable from a multi-touch event received from an interface device (not shown) capable of sensing multiple touch location concurrently. Further subsequently, when the second touch point is moved to X3,Y3 while the first touch point remains at X1,Y1, the interface device 110 sends a Move event containing XR′,YR′ to the multi-touch detector 150. The multi-touch detector applies heuristic analysis, determines that a multiple touch move event has occurred, and derives a revised location XE′,YE′ for the second touch. The multi-touch detector 150 then sends a Multi-touch move event containing X1,Y1 and XE′,YE′ to the application 125. Further subsequent movements of the second touch point are process similarly. The application 125 can apply contextual analysis to the Multi-touch move event, or to a series of move events, to interpret the moves as, for example, a pinching motion (e.g. indicating zoom out), a spreading motion (e.g. indicating zoom in), or a pivoting motion (e.g. indicating rotate object). The application 125 can further apply contextual analysis to the touch events, move events, and the touch point locations in order to identify incorrect or unexpected multiple touch occurrences and respond accordingly.

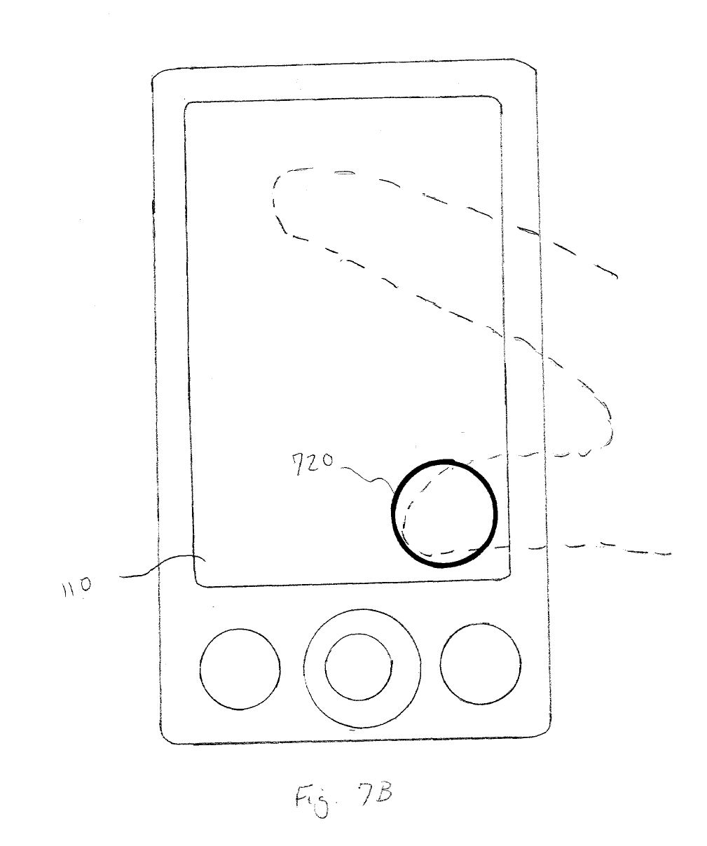

In an alternative embodiment, initial touch locations can be highlighted on the touch sensitive surface 112. FIGS. 7A-B are schematic representations of two exemplary embodiments for highlighting the initial (i.e. first) touch location on the touch sensitive surface 112. The initial touch locations are one or more designated areas on the touch sensitive surface 112 that can indicated by a marking 710 (e.g. silk-screened target) on the touch sensitive surface 112, or alternatively, in the case of a touch sensitive display device, by a visual highlighting 720 (e.g. shading) of portions of the display. For example, one initial touch location can be highlighted in each of the lower left-hand and lower right-hand corners of the touch sensitive surface 112. A user is instructed to locate the first touch of a multiple touch event within one of the initial touch locations. The multi-touch detector 150 can use the knowledge that a first touch occurred in an initial touch location to improve the accuracy of detecting a multiple touch occurrence, based on known and expected patterns, and to mitigate the inadvertent mistaking of a fast moving single touch event (e.g. a swish or a flick) for a multiple touch occurrence.

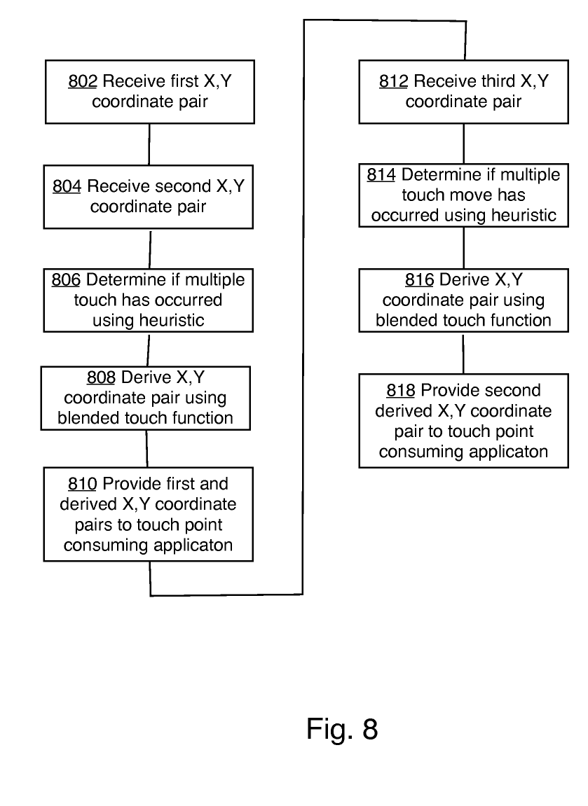

FIG. 8 is a flow diagram representing exemplary steps in a method 800 for providing multiple touch interface capability. The method 800 provides a multi-touch interface capability on a computing device (e.g. computing platform 100) having a single-touch interface device (e.g. interface device 110) where the single-touch interface device provides an X,Y coordinate pair that represents the location of a touch point on a surface of the interface device 110 at the occurrence of a single touch event or alternatively an X,Y coordinate pair that is a function of the locations of both a first touch point and a second touch point at the occurrence of a multiple touch event. In step 802, a first X,Y coordinate pair representing the location of a first touch point is received from the interface device 110. In step 804, a second X,Y coordinate pair when a second touch occurs from the interface device 110. In step 806, a determination is made if a multiple touch event has occurred by applying a heuristic based multiple touch detection analysis function to the first X,Y coordinate pair and the second X,Y coordinate pair. In step 808, when a multiple touch event is determine to have occurred in step 806, a derived X,Y coordinate pair representing the location of the second touch point by applying a heuristic based blended touch function to the first X,Y coordinate pair and the second X,Y coordinate pair is derived. In step 810, the first X,Y coordinate pair and the derived X,Y coordinate pair representing the location of the second touch point is provided to a touch point consuming application (e.g. operating system 120 or application 125). In step 812, a third X,Y coordinate pair when a movement of the second touch point occurs from the interface device 110. In step 814, a determination is made if a multiple touch move event has occurred by applying a heuristic based multiple touch detection analysis function to the first X,Y coordinate pair, second X,Y coordinate pair, and the third X,Y coordinate pair. In step 816, when a multiple touch move event is determine to have occurred in step 814, a second derived X,Y coordinate pair representing the location of the moved second touch point by applying a heuristic based blended touch function to the first X,Y coordinate pair and the third X,Y coordinate pair, is derived. In step 818, the second derived X,Y coordinate pair representing the location of the moved second touch point is provided to a touch point consuming application (e.g. operating system 120 or application 125).

A method according to the present invention can, for example, be implemented using the computing device 100 described above with reference to FIG. 1.

It will be apparent to one skilled in the art that numerous modifications and departures from the specific embodiments described herein may be made without departing from the spirit and scope of the present invention.

1. A computing device for providing a multi-touch interface capability comprising:
a single-touch interface device that provides:
an X,Y coordinate pair that represents the location of a touch point on a surface of the interface device responsive to the occurrence of a single touch event; and
an X,Y coordinate pair that is a function of the locations of both a first touch point and a second touch point responsive to the occurrence of a multiple touch event;
a multi-touch detector for:
determining if a multiple touch event has occurred by applying a heuristic based multiple touch detection analysis function to a first X,Y coordinate pair, provided by the interface device representing the location of a first touch point, and a second X,Y coordinate pair, provided by the interface device responsive to a second touch; and
deriving, when a multiple touch event is determine to have occurred, a derived X,Y coordinate pair representing the location of the second touch point by applying a heuristic based blended touch function to the first X,Y coordinate pair and the second X,Y coordinate pair; and
at least one of an operating system and an application, for receiving the first X,Y coordinate pair and the derived X,Y coordinate pair representing the location of the second touch point.

2. The computing device of claim 1, wherein each X,Y coordinate pair represents a location on a Cartesian plane corresponding to a substantially planar surface of the single-touch interface device.

3. The computing device of claim 1, wherein the multiple touch detection function determines a multiple touch event has occurred responsive to a distance between the first and second X,Y coordinate pairs and a time lapse between the first and second touches.

4. The computing device of claim 1, wherein the blended touch function comprises an algorithm based on X,Y coordinate pairs received from the interface device at a plurality of pre-determined combinations of first and second calibration touch points and X,Y coordinate pairs representing the actual locations of the first and second calibration touch points.

5. The computing device of claim 4, wherein the algorithm is a successive approximation mechanism that terminates responsive to one of: a pre-determined accuracy threshold, and a pre-determined number of the iterations.

6. The computing device of claim 1, wherein the blended touch function comprises look-up table based on X,Y coordinate pairs received from the interface device at a plurality of pre-determined combinations of first and second calibration touch points and X,Y coordinate pairs representing the actual locations of the first and second calibration touch points.

7. The computing device of claim 1, wherein the surface of the interface device comprises one or more indicated areas within which the first touch is to be placed.

8. The computing device of claim 1, wherein the interface device is a touch sensitive display device and the method further comprising the step of highlighting, on the touch sensitive display, the location of the first touch point responsive to the received first X,Y coordinate pair.

9. The computing device of claim 1, wherein:
the single-touch interface device is further provides a third X,Y coordinate pair when a movement of the second touch point occurs;
the multi-touch detector further for:
determining if a multiple touch move event has occurred by applying a heuristic based multiple touch detection analysis function to the first X,Y coordinate pair, second X,Y coordinate pair, and the third X,Y coordinate pair; and
deriving, when a multiple touch move event is determine to have occurred, a second derived X,Y coordinate pair representing the location of the moved second touch point by applying a heuristic based blended touch function to the first X,Y coordinate pair and the third X,Y coordinate pair; and
the at least one of an operating system and an application, further for receiving the second derived X,Y coordinate pair representing the location of the moved second touch point.

10. A method for providing a multi-touch interface capability on a computing device having a single-touch interface device, the single-touch interface device provides an X,Y coordinate pair that represents the location of a touch point on a surface of the interface device at the occurrence of a single touch event or alternatively an X,Y coordinate pair that is a function of the locations of both a first touch point and a second touch point at the occurrence of a multiple touch event, the method comprising the steps of:
receiving, from the interface device, a first X,Y coordinate pair representing the location of a first touch point;
receiving, from the interface device, a second X,Y coordinate pair when a second touch occurs;
determining if a multiple touch event has occurred by applying a heuristic based multiple touch detection analysis function to the first X,Y coordinate pair and the second X,Y coordinate pair;
deriving, when a multiple touch event is determine to have occurred, a derived X,Y coordinate pair representing the location of the second touch point by applying a heuristic based blended touch function to the first X,Y coordinate pair and the second X,Y coordinate pair; and
providing, to a touch point consuming application, the first X,Y coordinate pair and the derived X,Y coordinate pair representing the location of the second touch point.

11. The method of claim 10, wherein each X,Y coordinate pair represents a location on a Cartesian plane corresponding to a substantially planar surface of the single-touch interface device.

12. The method of claim 10, wherein the multiple touch detection function determines a multiple touch event has occurred responsive to a distance between the first and second X,Y coordinate pairs and a time lapse between the first and second touches.

13. The method of claim 10, wherein the blended touch function comprises an algorithm based on X,Y coordinate pairs received from the interface device at a plurality of pre-determined combinations of first and second calibration touch points and X,Y coordinate pairs representing the actual locations of the first and second calibration touch points.

14. The method of claim 13, wherein the algorithm is a successive approximation mechanism that terminates responsive to one of: a pre-determined accuracy threshold, and a pre-determined number of the iterations.

15. The method of claim 10, wherein the blended touch function comprises look-up table based on X,Y coordinate pairs received from the interface device at a plurality of pre-determined combinations of first and second calibration touch points and X,Y coordinate pairs representing the actual locations of the first and second calibration touch points.

16. The method of claim 10, wherein the surface of the interface device comprises one or more indicated areas within which the first touch is to be placed.

17. The method of claim 10, wherein the interface device is a touch sensitive display device and the method further comprising the step of highlighting, on the touch sensitive display, the location of the first touch point responsive to the received first X,Y coordinate pair.

18. The method of claim 10, further comprising the steps of:
receiving, from the interface device, a third X,Y coordinate pair when a movement of the second touch point occurs;
determining if a multiple touch move event has occurred by applying a heuristic based multiple touch detection analysis function to the first X,Y coordinate pair, second X,Y coordinate pair, and the third X,Y coordinate pair;
deriving, when a multiple touch move event is determine to have occurred, a second derived X,Y coordinate pair representing the location of the moved second touch point by applying a heuristic based blended touch function to the first X,Y coordinate pair and the third X,Y coordinate pair; and
providing, to a touch point consuming application, the second derived X,Y coordinate pair representing the location of the moved second touch point.
